(19) United States
(12) Patent Application Publication
(10) Pub. No.: US 2011/0199520 A1
(43) Pub. Date: Aug. 18, 2011

(54) Image processing apparatus and image processing method

(75) Inventor: Yusuke Katou, Kanagawa (JP)

(73) Assignee: Renesas Electronics Corporation, Kawasaki (JP)

(21) Appl. No.: 12/929,737

(22) Filed: Feb. 11, 2011

(30) Foreign Application Priority Data
Feb. 17, 2010 (JP) 2010-032141

(51) Int. Cl. H04N 5/335

(52) U.S. Cl. 348/280; 348/E05.091

(57) ABSTRACT

There are provided an image processing apparatus and an image processing method capable of performing weighted mean processing to suppress image blurriness. An image pickup system has a sensor in which R, Gb, Gr or B color filters are formed in predetermined positions of a matrix array of pixels, a reduction processing unit to perform reduction processing on an image obtained with the sensor, and a weighted mean processing unit, provided in a post-stage from the reduction processing unit and in a pre-stage from a pixel interpolation unit to convert Bayer format data obtained from the sensor into an RGB image by interpolation processing, which performs weighted mean processing on R, Gb, Gr and B pixel values as values of pixels corresponding to the R, Gb, Gr or B color filters without one of the R, Gb, Gr and B pixel values.

### CROSS-REFERENCE TO RELATED APPLICATIONS

The disclosure of Japanese Patent Application No. 2010-32141 filed on Feb. 17, 2010 including the specification, drawings and abstract is incorporated herein by reference in its entirety.

### BACKGROUND

1. Field of the Invention

The present invention relates to an image processing apparatus and an image processing method for performing reduction processing on photographed image data by thinning or addition, and more particularly to an image processing apparatus and an image processing method for performing weighted mean processing on reduction-processed data.

2. Description of Related Art

Japanese Published Unexamined Patent Application No. 2004-266369 discloses a technique of reading pixel information, while thinning the pixel information, from an X-Y address type solid-state image pickup device with color filters having predetermined color coding for matrix-arrayed pixels, for the purpose of achievement of a high frame rate and the like.

In this case, a pixel block in which plural pixels are mutually adjacent in line and column directions is used as one unit pixel block. In a state where such unit pixel blocks are arranged without overlapping each other, pixel information of the same color filter existing in the unit pixel blocks is read out as information for one pixel.

This is expressed as follows. Assuming that a (2k+3)×(2k+3) pixel block (k is a positive integer equal to or greater than 0) is a unit pixel block, all the image information regarding the same color within the unit block is added, thereby the pixel area is artificially increased. FIGS. 11A and 11B show a method of compressing pixel information amount by 3×3 pixel block; FIG. 12, by 5×5 pixel block; and FIG. 13, by 7×7 pixel block, i.e., compression of pixel information amount respectively by ratios of 1/9, 1/25 and 1/49. That is, as shown in these FIGS. 11A, 11B, 12 and 13, a pixel block (matrix) of an odd number of pixels×an odd number of pixels is handled as one pseudo pixel (pseudo pixel), then values of a pixel color representative of the pseudo pixel are added, and a pseudo pixel value is obtained.

### SUMMARY

However, in this method of adding values of pixel color representative of a matrix as disclosed in this Japanese Published Unexamined Patent Application No. 2004-266369, other color pixel values included in the matrix are deleted. Further, FIG. 14 shows combinations of additions upon compression of 2×2 pixel group as a unit block. FIG. 15 shows compressed data. As shown in FIG. 14, when the method is applied to a matrix having, not a pixel block of an odd number of pixels×an odd number of pixels but a pixel block of an even number of pixels×an even number of pixels as a unit block, among eight neighbor pixels around a processing object pixel, addition is performed between upper right, lower right, upper left and lower left pixels and the processing object pixel. However, as shown in FIG. 15, when an even number of pixels have no central pixel, i.e., the processing is performed by four-pixel block, the position between the second and third pixels is the center and no central pixel exists. Accordingly, the barycenter is shifted with respect to all the original pixels. Since the barycentric shift among the pixels causes nonuniformity of barycenter position by pixel, a periodic pattern occurs (FIG. 17A). In FIG. 17A, the smoothness of an oblique curve in an object A is different from that in an object B.

Accordingly, in the technique disclosed in Japanese Published Unexamined Patent Application No. 2003-264844, as shown in FIG. 16, based on a nonuniform pixel value, weighted mean processing is performed in accordance with distance between barycentric positions of pixels and correction is performed so as to obtain uniform pixel positions. FIG. 16 shows the weighted mean processing upon correction of the barycentric positions of pixels to positions indicated with “O”. FIG. 18 shows the corrected barycenters.

However, in the method disclosed in Japanese Published Unexamined Patent Application No. 2003-264844, although the occurrence of periodic pattern due to pixel barycentric shift can be suppressed, the image is blurred (FIG. 17B). That is, in the method disclosed in Japanese Published Unexamined Patent Application No. 2003-264844, pixel information is read while addition is performed by two horizontal pixels. Accordingly, weighted mean processing is performed on pixel values which are nonuniform due to the above-described reading to obtain uniform values. However, as the image is blurred as a result of the processing, the technique as a countermeasure is insufficient.

The present invention has been made in consideration of the above situation, and provides an image processing apparatus for converting an image, obtained with a solid-state image pickup device in which R, Gb and Gr or B color filters are formed in predetermined positions of a matrix array of pixels, into a reduced image, and performing weighted mean processing on the reduced image. The image processing apparatus has a weighted mean processing unit, which is provided in a pre-stage of a pixel interpolation unit to convert Bayer format data obtained from the solid-state image pickup device into an RGB image by interpolation processing and which performs weighted mean processing on R, Gb, Gr and B pixel values from the above-described R, Gb, Gr or B color filters except one or more pixel values, or reduces the ratio upon weighted mean processing for any one pixel value in comparison with the other pixel values.

Further, the present invention provides an image processing method for converting an image, obtained with a solid-state image pickup device in which R, Gb and Gr or B color filters are formed in predetermined positions of a matrix array of pixels, into a reduced image, and performing weighted mean processing on the reduced image. Prior to execution of pixel interpolation processing to convert Bayer format data obtained from the solid-state image pickup device into an RGB image by interpolation processing, weighted mean processing is performed on R, Gb, Gr and B pixel values from the above-described R, Gb, Gr or B color filters except one or more pixel values, or the ratio upon weighted mean processing for any one pixel value is reduced in comparison with the other pixel values.

In accordance with the present invention, regarding any one or more of the R, Gb, Gr and B pixels, a weighted mean value is not obtained. Otherwise, the ratio upon weighted mean processing for any one pixel value is reduced in comparison with the other pixel values, i.e., the amount of blurriness is reduced in comparison with that in the other pixel values. The weighted mean processing cannot avoid occurrence of blurriness. However, the blurriness can be suppressed by performing the weighted mean processing without any one of the pixel values or reducing the ratio upon weighted mean processing for any one of the pixel values (a mean value is obtained from a smaller number of pixels in comparison with other pixels).

According to the present invention, an image processing apparatus and an image processing method capable of performing weighed mean processing to suppress image blurriness can be provided.

### BRIEF DESCRIPTION OF THE DRAWINGS

The above and other object, features and advantages of the present invention will become more apparent from the following detailed description when taken in conjunction with the accompanying drawings wherein:

FIG. 1 is a block diagram showing an image pickup apparatus according to an embodiment of the present invention;

FIG. 2 is an explanatory view of positional correction by weighted mean processing by pixel color;

FIG. 3 illustrates pixel positions after the correction;

FIG. 4 is a table of respective pixel values of an input image;

FIG. 5 is a table of respective pixel values of an output image;

FIG. 6 is an explanatory view of positional correction without Gr pixels in the weighted mean processing;

FIG. 7 is an explanatory view of positional correction without Gb pixels in the weighted mean processing;

FIG. 8 is an explanatory view of positional correction without R pixels in the weighted mean processing;

FIG. 9 is an explanatory view of positional correction without B pixels in the weighted mean processing;

FIG. 10 is an explanatory view of positional correction without Gr and Gb pixels in the weighted mean processing;

FIGS. 11A and 11B are explanatory views of a method of compressing pixel information amount by 3×3 pixel block as a unit block, i.e., by a ratio of 1/9;

FIG. 12 is an explanatory view of the method of compressing pixel information amount by 5×5 pixel block as a unit block, i.e., by a ratio of 1/25;

FIG. 13 is an explanatory view of the method of compressing pixel information amount by 7×7 pixel block as a unit block, i.e., by a ratio of 1/49;

FIG. 14 illustrates combinations of additions upon compression by 2×2 pixel block as a unit block;

FIG. 15 illustrates compressed data;

FIG. 16 is an explanatory view of the weighted mean processing in Japanese Published Unexamined Patent Application No. 2003-264844;

FIG. 17A is an image sample in which a periodic pattern occurs due to pixel barycentric shift;

FIG. 17B is an image sample in which the image is blurred by application of the technique in Japanese Published Unexamined Patent Application No. 2003-264844; and

FIG. 18 illustrates corrected bar centers after the weighted mean processing in Japanese Published Unexamined Patent Application No. 2003-264844.

### DETAILED DESCRIPTION OF THE PREFERRED EMBODIMENTS

Hereinbelow, an embodiment to which the present invention is applied will be described in detail in accordance with the accompanying drawings. In the present embodiment, the present invention is applied to an image pickup apparatus such as a digital camera.

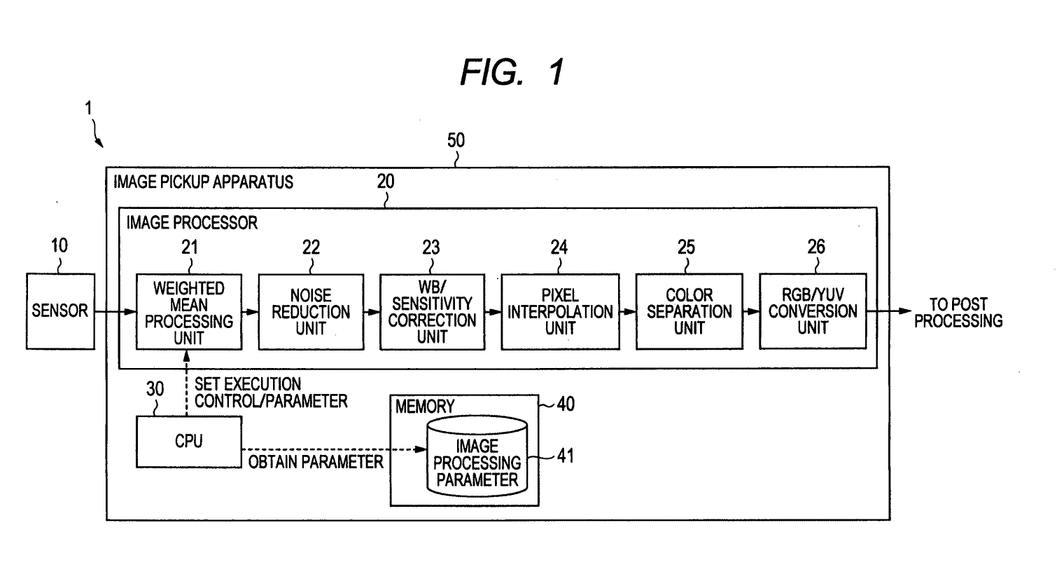

FIG. 1 shows an image pickup apparatus according to the present embodiment. An image pickup system 1 according to the present embodiment has a sensor 10 and an image pickup apparatus 50. The image pickup apparatus 50 has an image processing unit 20, a Central Processing Unit (CPU) 30 and a memory 40. The memory 40 holds an image processing parameter 41 and the like. The CPU 30 reads the image processing parameter 41 from the memory 40, controls execution of the respective elements of the image processing unit 20, and sets parameters.

The image processing unit 20 has a weighted mean processing unit 21, a noise reduction (NR) unit 22, a White Balance (WB)/sensitivity correction unit 23, a pixel interpolation unit 24, a color separation unit 25 and an RGB/YUV conversion unit 26.

The sensor 10, having a matrix array of pixels where R, Gb, Gr or B color filters are formed in predetermined positions of the respective pixels, outputs Bayer format RAW image data. Note that in the figures, an alphabet letter “R” indicates a pixel value in a position where a red color filter is formed; “B”, a pixel value in a position where a blue color filter is formed; “Gb” or “Gr”, a pixel value in a position where a green color filter is formed. The pixels are arrayed in matrix, where the pixel value of a pixel, formed in a blue color-filter pixel column and in a position where a green color filter is formed, is represented as “Gb”, and the pixel value of a pixel, formed in a red color-filter pixel column and in a position where a′green color filter is formed, is represented as “Gr”.

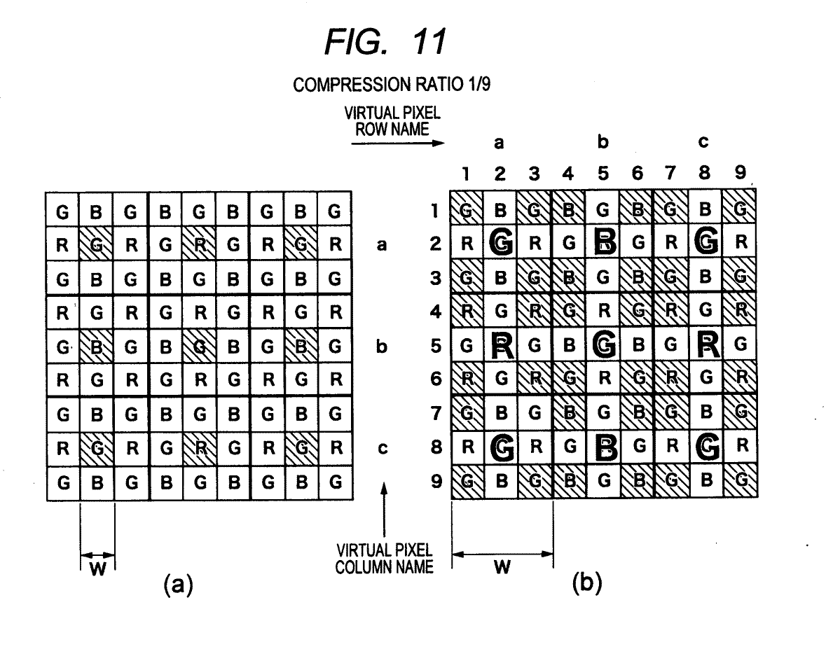

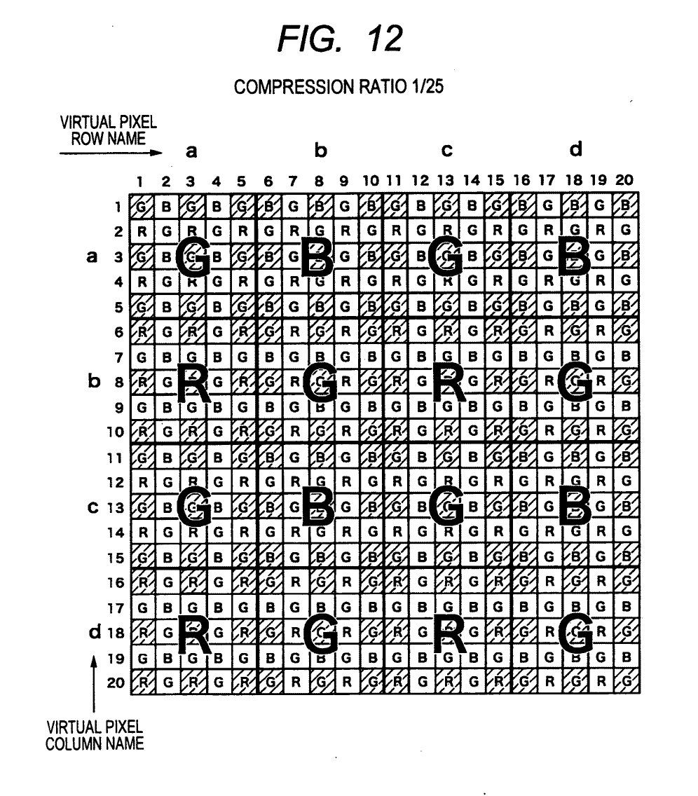

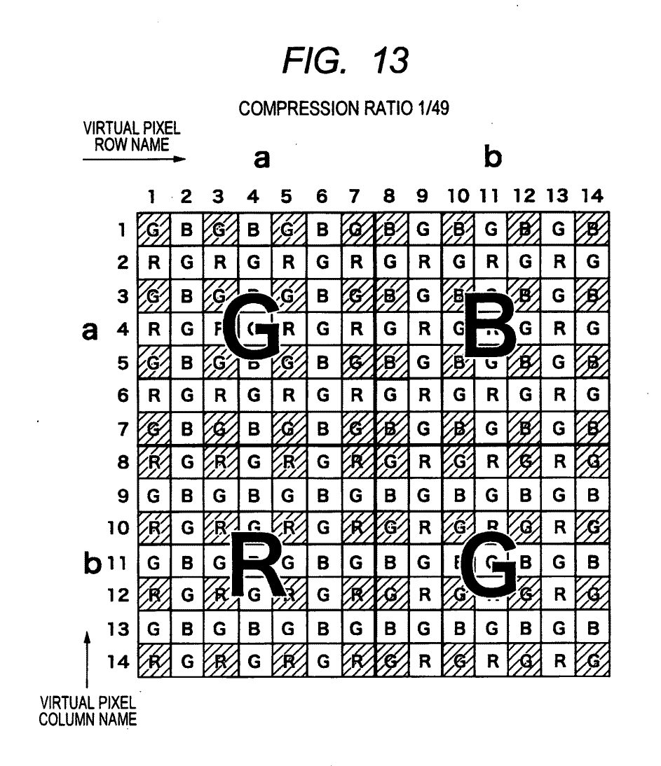

When image pickup is performed at a high frame rate to obtain small images upon preview or movie shooting, thinning, addition or weighted mean processing or the like is performed with operation mode setting of the sensor, so as to reduce the amount of output data and resulted representative values are outputted as shown in FIGS. 11A to 13, and a high frame-rate operation is realized. Hereinbelow, this processing will be referred to as reduction processing. Note that in the present embodiment, although the sensor 10 performs the reduction processing, it may be arranged such that a reduction processing unit is provided in the post-stage image processing unit 20; otherwise, the weighted mean processing unit 21 performs weighted mean processing after execution of the reduction processing.

The noise reduction unit 22 performs noise reduction on noise which occurs in the sensor 10. The noise reduction unit 22 has a function of controlling a reduction amount with respect to each color component since the amount of noise differs by color component in an image finally outputted to the post-stage processing unit in accordance with settings of other image processing's.

The WB/sensitivity correction unit 23 individually corrects the R, Gb, Gr, B pixel values so as to restore whiteness of a white portion, based on the content of the image. The WB/sensitivity correction unit 23 corrects the difference of sensitivity of the sensor with respect to each of the R, Gb, Gr and B pixel values in correspondence with the characteristic of the sensor. The pixel interpolation unit 24 converts the Bayer format raw image data into an RGB image.

The color separation unit 25 corrects mixture of different color component with each pixel color due to the characteristics of the color filters in the sensor 10. For example, when the R component includes the G or B component, the color separation unit 25 performs correction so as to remove the included G or B component. The RGB/YUV conversion unit 26 converts the RGB format image into a standard YUV format image used in cameras.

Then the image processing unit 20 according to the present embodiment has the weighted mean processing unit 21. The weighted mean processing unit 21 can be provided in any position in a post-stage from the above-described block to perform the above-described reduction processing and a pre-stage from the pixel interpolation unit 24 to convert raw data from the sensor 10 into an RGB image.

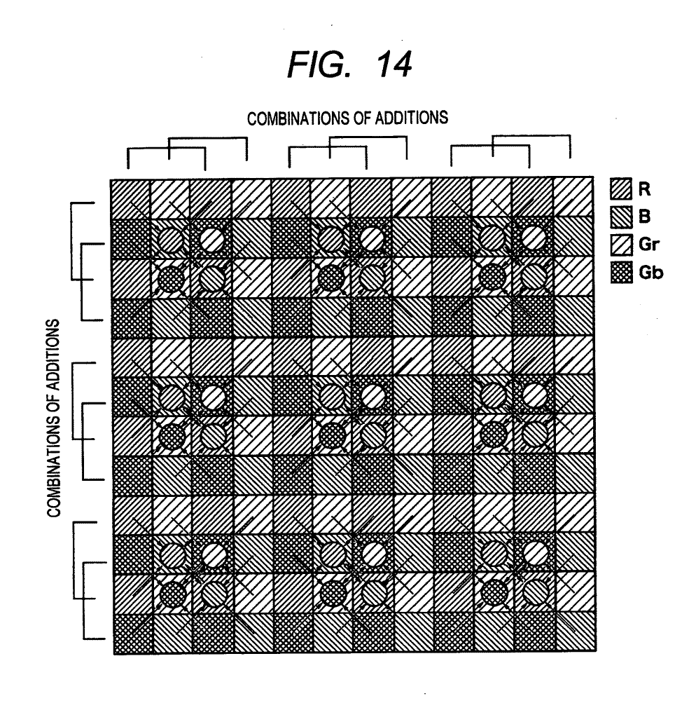

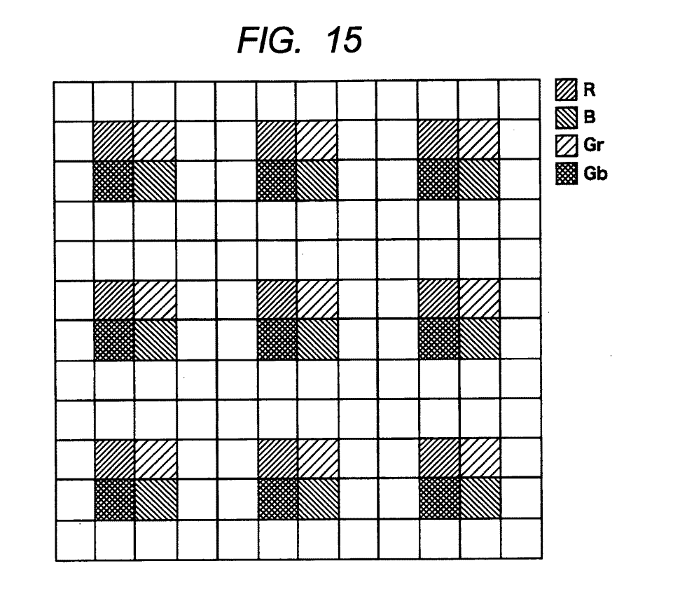

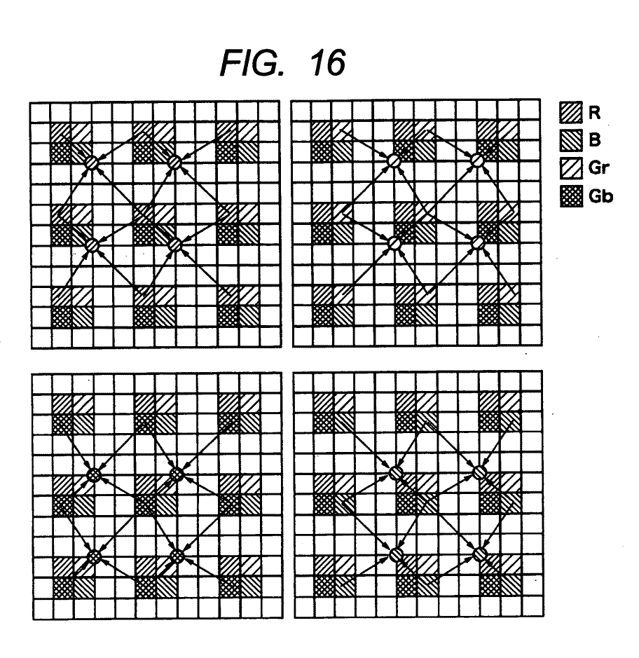

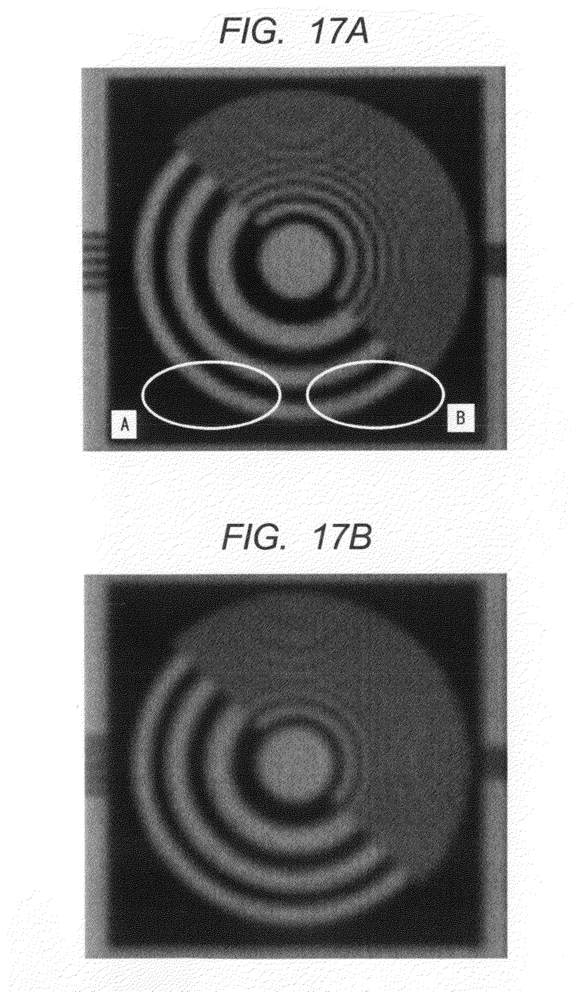

When the above-described sensor 10 performs the reduction processing, upon preview or movie shooting, as shown in FIGS. 14 and 15, in output data from the sensor, the respective representative pixels are not equally positioned with respect to the angle of field and unevenly positioned.

Accordingly, the weighted mean processing unit 21 performs weighted mean processing on the R, Gb, Gr and B pixel values in the image data from the sensor 10 except one or more pixel value.

In the above-mentioned Japanese Published Unexamined Patent Application No. 2003-264844, a mean value is obtained by two pixels in a horizontal direction. Then the nonuniform pixel values due to the mean processing by two pixels are changed to uniform pixel values by weighted mean processing, so as to suppress the occurrence of periodic pattern due to barycentric shift. On the other hand, in the present embodiment, the setting of weighted average coefficient is determined in consideration of the influence of the respective R, Gb, Gr and B color components on a final image, in addition to the barycentric shift amount (position coordinate distance), thereby blurriness in the image can be suppressed.

Note that in the present embodiment, among the four R, Gb, Gr and B pixels, one or two pixels are excluded upon weighted mean processing. That is, this exclusion is made for prevention of image blurriness due to excessive weighted mean processing. Accordingly, it may be arranged such that the ratio upon mean processing for any one pixel value is reduced in comparison with the other pixel values, i.e., the amount of blurriness is reduced in comparison with the other pixel values. Although the occurrence of blurriness cannot be avoided in weighted mean processing, when the ratio upon mean processing is reduced (a mean value is obtained from a smaller number of pixels in comparison with the other pixel values), the blurriness can be suppressed.

In a camera, an output image is in the YUV (or YCC) format for representation using luminance and chrominance components. At this time, image blurriness is caused mainly by blurriness in Y component as the luminance component. In conversion from RGB space into YUV space (or YCC space), the Y component is determined while the R, Gb, Gr and B components are weighted as in the case of the following example, and blurriness of the G component having high contribution ratio with respect to the Y component greatly influences blurriness in a final image. Note that in the RGB data inputted into the RGB/YUV conversion unit 26, the R data is obtained based on R pixel value data of the RAW data; the G data, based on Gr pixel value and Gb pixel value data of the RAW data; and the B data, based on B pixel value data of the RAW data.

Example of Y component determination:

Y=0.29900R+0.58700G+0.11400B

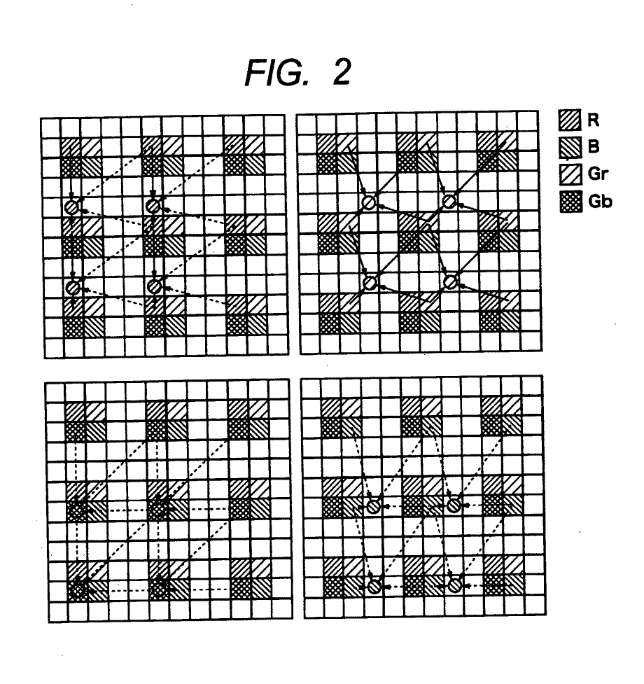

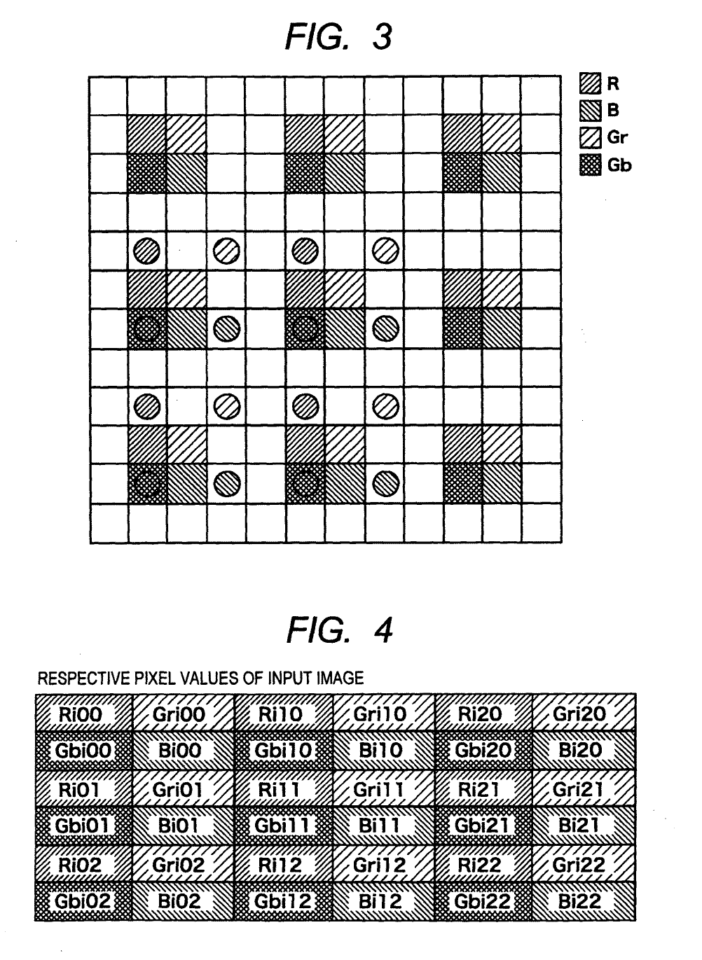

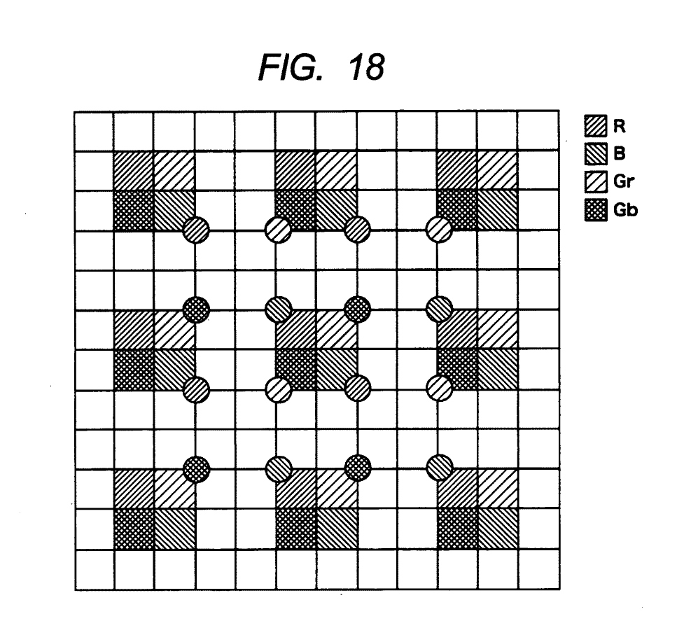

As shown in FIG. 2, to suppress the blurriness of the G component, weighted mean processing is performed by color component while weighted mean processing on the G pixels is avoided as much as possible, thus barycentric positions are corrected as shown in FIG. 3. FIG. 2 is an explanatory view of positional correction by weighted mean processing by pixel color. In FIG. 2, a symbol “O” indicates a pixel position obtained by weighted mean processing from the four nearest pixels among thinned pixels (hatched pixels). The weighted mean processing has been performed so as to bring the correction result “O” corresponds with the pixel barycenter. FIG. 3 illustrates the weighted mean processing upon correction of the pixel barycenters to the positions indicated with the symbols “O”. At this time, as a periodic pattern occurs when the barycentric positions are nonuniform, arrangement is performed so as to avoid occurrence of crude density in the corrected barycentric position as in the case of FIG. 18.

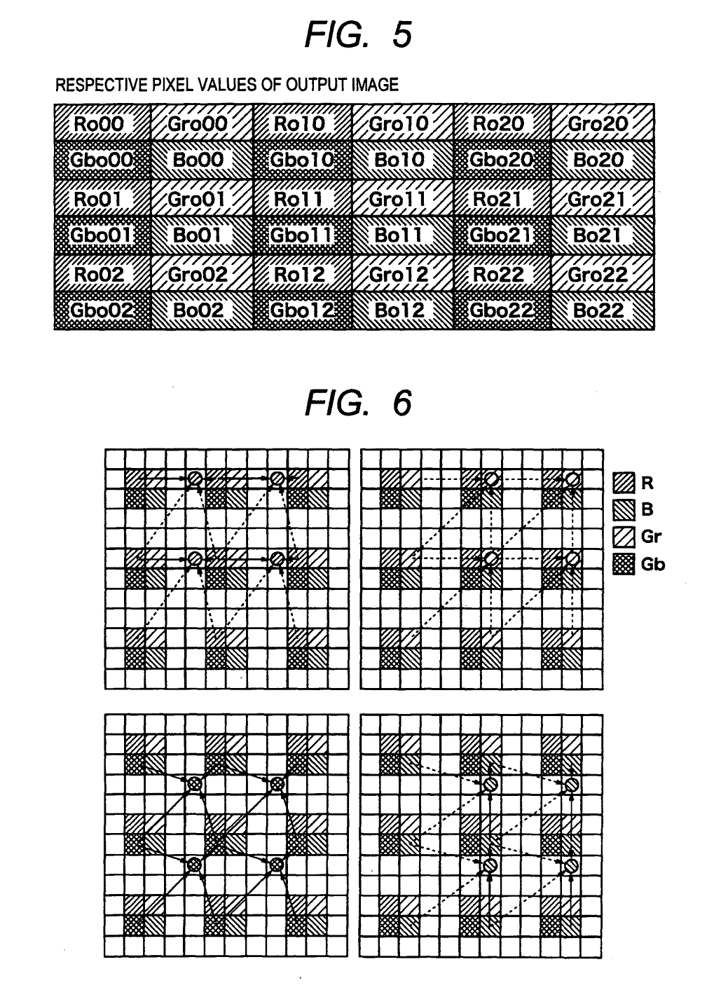

FIG. 4 shows respective pixel values of an input image. FIG. 5 shows respective pixel values of an output image. As parameters used in weighted mean processing, four coefficients a to d are used by pixel color as follows:

R pixel coefficients: kr_a, kr_b, kr_c, kr_d
Gr pixel coefficients: kgr_a, kgr_b, kgr_c, kgr_d
Gb pixel coefficients: kgb_a, kgb_b, kgb_c, kgb_d
B pixel coefficients: kb_a, kb_b, kb_c, kb_d

At this time, for example, R pixel output values can be obtained with the following calculation. Note that output values of the other pixels are similarly obtained.

Ro00=(kr_{—}a×Ri00)+(kr_{—}b×Ri10)+(kr_{—}c×Ri01)+(kr_{—}d×Ri11)

Ro10=(kr_{—}a×Ri10)+(kr_{—}b×Ri20)+(kr_{—}c×Ri11)+(kr_{—}d×Ri21)

Ro01=(kr_{—}a×Ri01)+(kr_{—}b×Ri11)+(kr_{—}c×Ri02)+(kr_{—}d×Ri12)

RoMN=(kr_{—}a×RiMN)+(kr_{—}b×Ri(M+1)N)+(kr_{—}c×RiM(N+1))+(kr_{—}d×Ri(M+1)(N+1))

The respective pixel coefficients when the Gr pixel is not used in the weighted mean processing are as follows. FIG. 6 shows positional correction without Gr pixels in the weighted mean processing. In FIG. 6 and the subsequent FIGS. 7 to 9, 4×4 (16) pixels are reduced to four R, Gb, Gr and R pixels, and further, regarding each of the R, Gb, Gr and R pixels, a weighted average value is obtained from four neighbor pixels. In FIG. 6, among four hatched pixels, an upper left pixel is an R pixel; an upper right pixel, a Gr pixel; a lower right pixel, a B pixel; and a lower left pixel, a Gb pixel.

R pixel coefficients: kr_a=0.25, kr_b=0.75, kr_c=0, kr_d=0
Gr pixel coefficients: kgr_a=0, kgr_b=1, kgr_c=0, kgr_d=0
Gb pixel coefficients: kgb_a=0.1875, kgb_b=0.5625, kgb_c=0.0625, kgb_d=0.1875
B pixel coefficients: kb_a=0, kb_b=0.75, kb_c=0, kb_d=0.25

That is, in FIG. 6, as a weighted average is not obtained regarding the Gr pixel, the upper right pixel value is a Gr pixel value. Note that in the present embodiment, when weighted mean processing is performed except only one point, mutually different pixel values are used among the upper left, upper right, lower left and lower right pixels in accordance with pixel color, since it is assumed that the interval between the central positions of the respective pixel colors are constant. Accordingly, in a case where interpolation is performed on four points among 16 pixels, as long as the method for averaging upon ½ reduction sensor output is similar to that in the present embodiment, when weighted mean processing is performed except R pixel, the upper left pixel value is adopted as an R pixel value. When the weighted mean processing is performed except Gb pixel, the lower left pixel value is adopted as a Gb pixel value. When the weighted mean processing is performed except B pixel, the lower right pixel value is adopted as a B pixel value.

Further, as shown in the upper left part of FIG. 6, regarding the R pixel, the weighted mean processing is performed by a ratio of upper left pixel coefficient 0.25 and upper right pixel value 0.75. Further, regarding the Gb pixel, as shown in the lower left part of FIG. 6, the weighted mean processing is performed by a ratio of upper left and right coefficients 0.1875, upper right pixel coefficient 0.5625 and lower left pixel coefficient 0.0625. Further, regarding the B pixel, as shown in the lower right part of FIG. 6, the weighted mean processing is performed by a ratio of lower right pixel coefficient 0.25 and upper right pixel coefficient 0.75.

That is, as described in the above case, assuming that the four nearest pixels are upper left, upper right, lower left and lower right pixels R1 to R4, upper left, upper right, lower left and lower right pixels Gb1 to Gb4, upper left, upper right, lower left and lower right pixels Gr1 to Gr4, and upper left, upper right, lower left and lower right pixels B1 to B4, weighted mean values can be obtained with the following expressions.

R pixel=0.25×R1+0.75×R2+0×R3+0×R4

Gr pixel=0×Gr1+1×Gr2+0×Gr3+0×Gr4

Gb pixel=0.1875×Gb1+0.5625×Gb2+0.0625×Gb3+0.1875×Gb4

B pixel=0×B1+0.75×B2+0×B3+0.25×B4

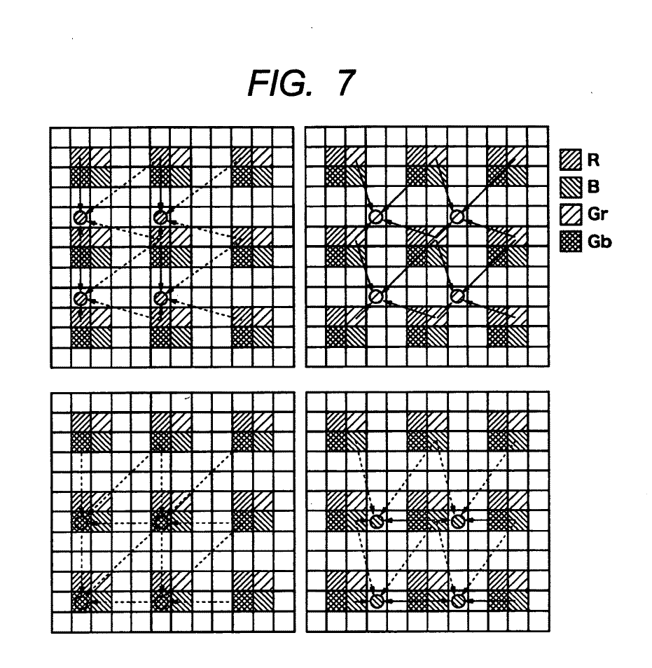

Hereinbelow, the respective pixel coefficients are given when the Gb pixels are not used in weighted mean processing. FIG. 7 is an explanatory view of positional correction without Gb pixels in the weighted mean processing.

R pixel coefficients: kr_a=kr_b=0, kr_c=0.75, kr_d=0
Gr pixel coefficients: kgr_a=0.1875, kgr_b=0.0625, kgr_c=0.5625, kgr_d=0.1875
Gb pixel coefficients: kgb_a=0, kgb_b=0, kgb_c=1, kgb_d=0
B pixel coefficients: kb_a=0, kb_b=0, kb_c=0.75, kb_d=0.25

That is, as described in the above case, assuming that the four nearest pixels are upper left, upper right, lower left and lower right pixels R1 to R4, upper left, upper right, lower left and lower right pixels Gb1 to Gb4, upper left, upper right, lower left and lower right pixels Gr1 to Gr4, and upper left, upper right, lower left and lower right pixels B1 to B4, weighted mean values can be obtained with the following expressions:

R pixel=0.25×R1+0×R2+0.75×R3+0×R4

Gr pixel=0.1875×Gr1+0.0625×Gr2+0.5625×Gr3+0.1875×Gr4

Gb pixel=0×Gb1+0×Gb2+1×Gb3+0×Gb4

B pixel=0×B1+0×B2+0.75×B3+0.25×B4

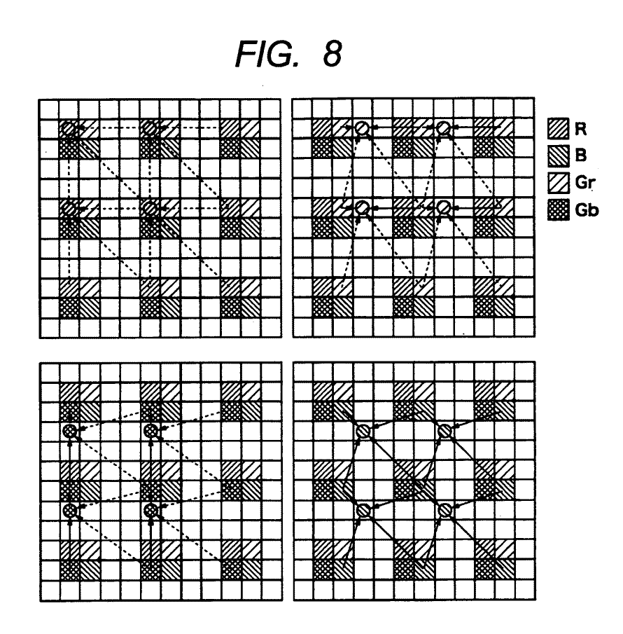

Hereinbelow, the respective pixel coefficients are given when the R pixels are not used in weighted mean processing. FIG. 8 is an explanatory view of positional correction without R pixels in the weighted mean processing.

R pixel coefficients: kr_a=1, kr_b=0, kr_c=0, kr_d=0
Gr pixel coefficients: kgr_a=0.75, kgr_b=0.25, kgr_c=0, kgr_d=0
Gb pixel coefficients: kgb_a=0.75, kgb_b=0, kgb_c=0.75, kgb_d=0
B pixel coefficients: kb_a=0.5625, kb_b=0.1875, kb_c=0.1875, kb_d=0.0625

That is, as described in the above case, assuming that the four nearest pixels are upper left, upper right, lower left and lower right pixels R1 to R4, upper left, upper right, lower left and lower right pixels Gb1 to Gb4, upper left, upper right, lower left and lower right pixels Gr1 to Gr4, and upper left, upper right, lower left and lower right pixels B1 to B4, weighted mean values can be obtained with the following expressions:

R pixel=1×R1+0×R2+0×R3+0×R4

Gr pixel=0.75×Gr1+0.25×Gr2+0×Gr3+0×Gr4

Gb pixel=0.75×Gb1+0×Gb2+0.25×Gb3+0×Gb4

B pixel=0.5625×B1+0.1875×B2+0.1875×B3+0.0625×B4

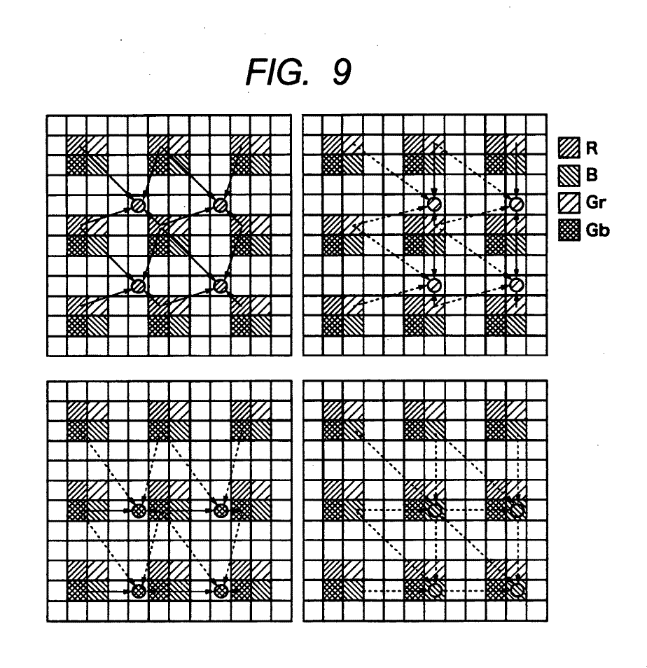

Hereinbelow, the respective pixel coefficients are given when the B pixels are not used in weighted mean processing. FIG. 9 is an explanatory view of positional correction without B pixels in the weighted mean processing.

R pixel coefficients: kr_a=0.0625, kr_b=0.1875, kr_c=0.1875, kr_d=0.5625
Gr pixel coefficients: kgr_a=0, kgr_b=0.25, kgr_c=0, kgr_d=0.75
Gb pixel coefficients: kgb_a=0, kgb_b=0, kgb_c=0.25, kgb_d=0.75
B pixel coefficients: kb_a=0, kb_b=0, kb_c=0, kb_d=1

That is, as described in the above case, assuming that the four nearest pixels are upper left, upper right, lower left and lower right pixels R1 to R4, upper left, upper right, lower left and lower right pixels Gb1 to Gb4, upper left, upper right, lower left and lower right pixels Gr1 to Gr4, and upper left, upper right, lower left and lower right pixels B1 to B4, weighted mean values can be obtained with the following expressions.

R pixel=0.0625×R1+0.1875×R2+0.1875×R3+0.5625×R4

Gr pixel=0×Gr1+0.25×Gr2+0×Gr3+0.75×Gr4

Gb pixel=0×Gb1+0×Gb2+0.25×Gb3+0.75×Gb4

B pixel=0×B1+0×B2+0×B3+1×B4

Further, in the above examples, one pixel value is calculated from four pixel values. However, the number of pixels used in the calculation is not limited to four. For example, a mean value can be obtained from nine pixel values as follows:

RoMN=(kr_{—}a×Ri(M−1)(N−1))+(kr_{—}b×RiM(N−1))+(kr_{—}c×Ri(M+1)(N−1)+(kr_{—}d×Ri(M−1)N)+(kr_{—}e×RiMN)+(kr_{—}f×Ri(M+1)N)+(kr_{—}g×Ri(M−1))(N+1))+(kr_{—}h×RiM(N+1))+(kr_{—}i×Ri(M+1)(N+1))

Next, in the present embodiment, weighted mean processing is performed except one of R, Gr, Gb and B pixels. Next, as to which of the R, Gr, Gb and B pixels will be preferable to be excluded from the weighted mean processing will be described.

First, in RGB-to-YUV conversion, considering the blurriness of the G component with high contributing ratio to the Y component, it is preferable not to perform weighted mean processing on the B or R component.

When one of Gr and Gb components is excluded in the weighted mean processing, the G component blurriness of the other one of Gr and Gb components is maximum. Since pixel interpolation is performed with reference to peripheral pixels in RGB format, when a blurred G component exists among the near pixels, the RGB-converted G component is also blurred.

On the other hand, when one of B and R is excluded, although the Gr and Gb components are blurred to the same degree, the blurriness is not the worst in any of these components, and the degree of blurriness is not so serious in comparison with the weighted mean processing except Gr or Gb component. Accordingly, it is preferable to perform weighted mean processing without R or B component.

Note that as to whether R or B component is excluded from the weighted mean processing, it is preferable to perform the weighted mean processing without R component from the viewpoint of contribution ratio in RGB-to-YUV conversion. However, from the viewpoint of total image quality including feeling of noise or the like, since “blurriness”=“noise reduction” may hold, such determination on balance may be required.

For example, in some system, since the sensitivity of the sensor is low in R pixels, when noise with respect to R component is high due to multiplication of R pixel value by a coefficient by sensitivity ratio correction, blurriness is intentionally caused in the R pixels by performing “weighted mean processing without B”, thereby the noise is reduced and the general image quality is improved. Note that as described above, in a case where the degree of weighted mean processing for the pixel value B is reduced, i.e., a weighted mean value is obtained from other pixels in the four pixels in place of weighted mean processing without B pixel value, a weighted mean value as a pixel B value may be obtained from two pixels.

That is, in the image processing apparatus according to the present embodiment, the coefficients to define barycentric positions are determined in consideration of influence on the image quality of a final image by a combination of influence on the occurrence of blurriness and noise by pixel color by weighted mean processing and other image processing parameters, in addition to simple two-dimensional distance, thereby general image quality can be improved.

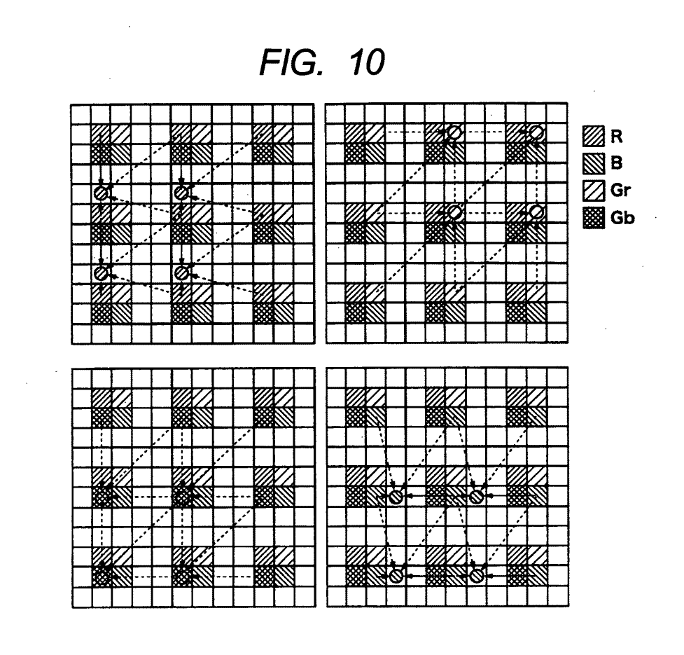

Next, an example where two colors are not mixed will be described. In this case, the Gr and Gb components are excluded from weighted mean processing as the best countermeasure to prevent occurrence of blurriness. FIG. 10 is an explanatory view of positional correction without Gr and Bb pixels in the weighted mean processing. Note that regarding positions where the R and B components are mixed, the four points R, Gr, Gb and B are arranged on a parallelogram. Such arrangement conflicts with pixel interpolation on the presumption that the four points horizontally and vertically arranged, which causes inconvenience such as swinging of a straight line in the image. Accordingly, since the method of weighted mean processing except two or more points causes a different type of degradation due to arrangement of non-vertical or non-horizontal arrangement of barycentric positions, the method of weighted mean processing without one point to enable vertical or horizontal arrangement of barycentric positions and prevent occurrence of crude density is superior.

Note that the present invention is not limited to the above embodiment and various changes and modifications can be made within the spirit and scope of the present invention.

For example, in the above embodiment, the invention is described with a hardware structure. However, such structure does not pose any limitation on the invention. The present invention may be realized by performing arbitrary processing by execution of a computer program with a CPU. In this case, it may be arranged such that the computer program is recorded on a recording medium and the medium is provided; otherwise, the program may be transmitted via the Internet or other transmission medium.

What is claimed is:

1. An image processing apparatus for converting a Bayer format image, obtained with a solid-state image pickup device in which R, Gb and Gr or B color filters are formed in predetermined positions of a matrix array of pixels, into a reduced image, and performing weighted mean processing on the reduced image, comprising:
a weighted mean processing unit that outputs a weighted mean value calculated from four types of pixels in the Bayer format image, inputted from the solid-state image pickup device, corresponding to the positions in which the color filters are formed, by a lower ratio upon weighted mean processing for at least one pixel value in comparison with other pixel values; and
a pixel interpolation unit that converts the image into an RGB image based on the outputted weighted mean value.

2. The image processing apparatus according to claim 1, wherein the weighted mean processing unit performs the weighted mean processing on the R, Gb, Gr and B pixels except the R pixel.

3. The image processing apparatus according to claim 1, wherein the weighted mean processing unit performs the weighted mean processing on the R, Gb, Gr and B pixels except the B pixel.

4. The image processing apparatus according to claim 1, wherein the weighted mean processing unit performs the weighted mean processing on the R, Gb, Gr and B pixels except the Gb or Gr pixel.

5. The image processing apparatus according to claim 1, wherein, assuming that the four nearest pixels are upper left, upper right, lower left and lower right pixels R1 to R4, upper left, upper right, lower left and lower right pixels Gb1 to Gb4, upper left, upper right, lower left and lower right pixels Gr1 to Gr4, and upper left, upper right, lower left and lower right pixels B1 to B4, weighted mean values can be obtained with the following expressions:
R pixel=1×R1+0×R2+0×R3+0×R4
Gr pixel=0.75×Gr1+0.25×Gr2+0×Gr3+0×Gr4
Gb pixel=0.75×Gb1+0×Gb2+0.25×Gb3+0×Gb4
B pixel=0.5625×B1+0.1875×B2+0.1875×B3+0.0625×B4

6. The image processing apparatus according to claim 1, wherein, assuming that the four nearest pixels are upper left, upper right, lower left and lower right pixels R1 to R4, upper left, upper right, lower left and lower right pixels Gb1 to Gb4, upper left, upper right, lower left and lower right pixels Gr1 to Gr4, and upper left, upper right, lower left and lower right pixels B1 to B4, weighted mean values can be obtained with the following expressions:
R pixel=0.25×R1+0.75×R2+0×R3+0×R4
Gr pixel=0×Gr1+1×Gr2+0×Gr3+0×Gr4
Gb pixel=0.1875×Gb1+0.5625×Gb2+0.0625×Gb3+0.1875×Gb4
B pixel=0×B1+0.75×B2+0×B3+0.25×B4

7. The image processing apparatus according to claim 1, wherein, assuming that the four nearest pixels are upper left, upper right, lower left and lower right pixels R1 to R4, upper left, upper right, lower left and lower right pixels Gb1 to Gb4, upper left, upper right, lower left and lower right pixels Gr1 to Gr4, and upper left, upper right, lower left and lower right pixels B1 to B4, weighted mean values can be obtained with the following expressions:
R pixel=0.25×R1+0×R2+0.75×R3+0×R4
Gr pixel=0.1875×Gr1+0.0625×Gr2+0.5625×Gr3+0.1875×Gr4
Gb pixel=0×Gb1+0×Gb2+1×Gb3+0×Gb4
B pixel=0×B1+0×B2+0.75×B3+0.25×B4

8. The image processing apparatus according to claim 1, wherein, assuming that the four nearest pixels are upper left, upper right, lower left and lower right pixels R1 to R4, upper left, upper right, lower left and lower right pixels Gb1 to Gb4, upper left, upper right, lower left and lower right pixels Gr1 to Gr4, and upper left, upper right, lower left and lower right pixels B1 to B4, weighted mean values can be obtained with the following expressions:
R pixel=0.0625×R1+0.1875×R2+0.1875×R3+0.5625×R4
Gr pixel=0×Gr1+0.25×Gr2+0×Gr3+0.75×Gr4
Gb pixel=0×Gb1+0×Gb2+0.25×Gb3+0.75×Gb4
B pixel=0×B1+0×B2+0×B3+1×B4

9. The image processing apparatus according to claim 1, further comprising:
a solid-state image pickup device in which R, Gb and Gr or B color filters are formed in predetermined positions of a matrix array of pixels; and
an image conversion unit that converts an image obtained with the solid-state image pickup device into a reduced image,
wherein the weighted mean processing unit is provided in a post-stage from the image conversion unit and in a pre-stage from the pixel interpolation unit to convert raw data obtained from the solid-state image pickup device into an RGB image.

10. The image processing apparatus according to claim 1, wherein the reduced image is obtained by performing reduction processing on the image obtained from the solid-state image pickup device.

11. An image processing method for converting a Bayer format image, obtained with a solid-state image pickup device in which R, Gb and Gr or B color filters are formed in predetermined positions of a matrix array of pixels, into a reduced image, and performing weighted mean processing on the reduced image, comprising:
outputting a weighted mean value calculated from four types of pixels in the Bayer format image, inputted from the solid-state image pickup device, corresponding to the positions in which the color filters are formed, by a lower ratio upon the weighted mean processing for at least one pixel value in comparison with other pixel values; and
converting the image into an RGB image based on the outputted weighted mean value.
